(19) United States
(12) Patent Application Publication
(10) Pub. No.: US 2025/0208709 A1
(43) Pub. Date: Jun. 26, 2025

(54) VR CONTROLLER PROTECTIVE SLEEVE, VR CONTROLLER ASSEMBLY, AND VR DEVICE

(71) Applicant: Shenzhen Hongjiantou Technology Co., Ltd., Shenzhen (CN)

(72) Inventor: Zhinan Zhang, Shenzhen (CN)

(21) Appl. No.: 18/969,252

(22) Filed: Dec. 4, 2024

(30) Foreign Application Priority Data
Dec. 25, 2023 (CN) 202323534622.6
Feb. 2, 2024 (CN) 202420261103.2

(51) Int. Cl. G06F 3/01

(52) U.S. Cl. CPC G06F 3/014; G06F 3/017

(57) ABSTRACT

The present application provides a VR controller protective sleeve, a VR controller assembly, and a VR device, wherein the VR controller protective sleeve includes a light transmitting part and a protective sleeve main body; the protective sleeve main body is made of an opaque material and is provided with an accommodating cavity used for accommodating at least one part of a VR controller; and the light transmitting part is made of a light transmitting material and is disposed on a position corresponding to at least one optical signal transmission port of the VR controller. The present application can protect the VR controller from sliding without affecting the use of an infrared sensor of the VR controller, thereby improving the convenience.

### CROSS REFERENCES TO RELATED APPLICATION

This application claims priorities of Chinese Patent Application No. 202323534622.6 filed on Dec. 25, 2023 and No. 202420261103.2 filed on Feb. 2, 2024, the entire contents of which are hereby incorporated by reference.

### TECHNICAL FIELD

The present application relates to the technical field of VR (Virtual Reality) devices, in particular to a VR controller protective sleeve, a VR controller assembly, and a VR device.

### BACKGROUND ART

A VR controller, commonly known as a VR handle, is used for controlling a VR device. The VR handle is internally provided with an infrared sensor, the VR handle follows the limb activity of a user and generates a corresponding signal, and the generated signal interacts with the VR device through the infrared sensor, thereby enhancing the sense of reality. Most of current VR handles are generally made of plastics. In order to improve the handfeeling of the user, the shape of the VR handle is usually fitted to a curve of a human hand, and the VR handle is relatively smooth; and when the user performs some large-range movements, the VR handle is easy to throw out.

In order to solve the above-mentioned problem, it is more common to sleeve a protective sleeve on the VR handle to prevent the VR handle from slipping out of the human hand. However, since the infrared sensor is built in the VR handle, the traditional protective sleeve will either affect the use of the infrared sensor or need to additionally drill the protective sleeve to avoid affecting the infrared sensor, that is, there has been no protective sleeve suitable for the VR handle at present.

### SUMMARY OF THE INVENTION

The present application provides a VR controller protective sleeve, a VR controller assembly, and a VR device, and aims at solving the problem that there has been no protective sleeve suitable for a VR controller at present.

In a first aspect, the present application provides a VR controller protective sleeve being applied to a VR controller, and including:
a protective sleeve main body, the protective sleeve main body being made of an opaque material and being provided with an accommodating cavity used for accommodating at least one part of the VR controller; and
a light transmitting part, the light transmitting part being made of a light transmitting material and being disposed on a position corresponding to at least one optical signal transmission port of the VR controller.

Further, the protective sleeve main body is integrated with the light transmitting part.

Further, the accommodating cavity of the protective sleeve main body comprises a first opening; and

the light transmitting part is disposed in the first opening.

Further, the light transmitting part is disposed around the first opening.

Further, at least one part of the light transmitting part extends inwards along the first opening so as to fix the VR controller into the accommodating cavity of the protective sleeve main body.

Further, the VR controller is provided with a battery component, the VR controller protective sleeve is provided with a battery mounting structure, and the battery mounting structure comprises:
a mounting hole disposed in a position, corresponding to the battery component of the VR controller, on the protective sleeve main body; and
a covering member disposed in the mounting hole and connected to the protective sleeve main body to cover the mounting hole.

Further, a surface, facing the accommodating cavity, of the covering member is provided with at least one convex part, and the convex part is used for fitting to the battery component.

Further, two sides of the convex part are provided with limiting parts.

Further, one side of the covering member is reversibly connected to the protective sleeve main body.

Further, the covering member is integrated with the protective sleeve main body.

In a second aspect, the present application further provides a VR controller assembly, including:
a VR controller; and
a VR controller protective sleeve, the VR controller protective sleeve sleeving the VR controller;

wherein the VR controller protective sleeve includes:
a protective sleeve main body, the protective sleeve main body being made of an opaque material and being provided with an accommodating cavity used for accommodating at least one part of the VR controller; and
a light transmitting part, the light transmitting part being made of a light transmitting material and being disposed on a position corresponding to at least one optical signal transmission port of the VR controller.

In a third aspect, the present application further provides a VR device, including:
a VR controller;
a VR controller protective sleeve, the VR controller protective sleeve sleeving the VR controller; and
a VR host;

wherein the VR controller protective sleeve includes:
a protective sleeve main body, the protective sleeve main body being made of an opaque material and being provided with an accommodating cavity used for accommodating at least one part of the VR controller; and
a light transmitting part, the light transmitting part being made of a light transmitting material and being disposed on a position corresponding to at least one optical signal transmission port of the VR controller.

The VR device disclosed in the present application includes the VR controller assembly, the VR controller assembly includes the VR controller and the VR controller protective sleeve, the VR controller protective sleeve includes the light transmitting part and the protective sleeve main body provided with the accommodating cavity used for accommodating the at least one part of the VR controller, the light transmitting part is disposed on the position corresponding to the at least one optical signal transmission port of the VR controller and has light transparency, and when the VR controller is accommodated in the protective sleeve, the infrared sensor of the VR controller can normally receive and send an infrared signal through the light transmitting part, which avoids affecting the normal use of the infrared sensor of the VR controller, and improves the use experience of a user.

### BRIEF DESCRIPTION OF THE DRAWINGS

In order to describe the technical solutions in the embodiments of the present application more clearly, the accompanying drawings required for describing the embodiments will be briefly introduced below. Obviously, the accompanying drawings in the following description show only some embodiments of the present application, and those of ordinary skill in the art can still derive other accompanying drawings from these accompanying drawings without creative work.

FIG. 1 is an overall structural diagram of a left VR controller protective sleeve provided in an embodiment of the present application;

FIG. 2 is a structural diagram of a light transmitting part in FIG. 1;

FIG. 3 is a structural diagram of a protective sleeve main body in FIG. 1;

FIG. 4 is an overall structural diagram of a right VR controller protective sleeve provided in an embodiment of the present application;

FIG. 5 is a structural diagram of a light transmitting part in FIG. 4;

FIG. 6 is a structural diagram of a protective sleeve main body in FIG. 4;

FIG. 7 is an overall structural diagram of a VR controller protective sleeve in an opened state provided in another embodiment of the present application;

FIG. 8 is an overall structural diagram of a VR controller protective sleeve in a closed state provided in another embodiment of the present application; and

FIG. 9 is an overall structural diagram of a VR controller assembly provided in an embodiment of the present application.

Reference signs: 1000, VR controller assembly; 100, VR controller protective sleeve; 10, light transmitting part; 20, protective sleeve main body; 21, accommodating cavity; 22, first opening; 23, second opening; 24, third opening; 25, first extension part; 26, second extension part; 27, fourth opening; 28, fifth opening; 30, binding band; 40, battery mounting structure; 41, mounting hole; 50, covering member; 51, convex part; 52, limiting part; and 200, VR controller.

### DETAILED DESCRIPTION OF THE INVENTION

Technical solutions in the embodiments of the present application will be described clearly and completely below in conjunction with the accompanying drawings in the embodiments of the present application. Obviously, the described embodiments are only a part of the embodiments of the present application, not all the embodiments. Based on the embodiments in the present application, all other embodiments obtained by those of ordinary skill in the art without creative work shall fall within the protection scope of the present application.

It should be understood that when used in the present description and the appended claims, terms “include” and “contain” indicate the existence of described features, entireties, operations, elements and/or components, but does not exclude the existence or addition of one or more other features, entireties, operations, elements, components and/or sets thereof.

It should be further understood that the terms used in the description of the present application are only intended to describe specific embodiments, rather than to limit the present application. As used in the description and the appended claims of the present application, a singular form “one”, “a” or “the” is intended to include a plural form unless other situations are clearly indicated in the context. It should be further understood that the term “and/or” used in the description and the appended claims of the present application refers to one or any combination or all combinations of related listed items and includes these combinations.

In addition, directional terms such as “upper”, “lower”, “front”, “rear”, “left”, “right”, “inner”, “outer” and “side” mentioned in the present application only directions indicated with reference to the accompanying drawings and a use state of a product. Therefore, the used directional terms are intended to describe and understand the present application, rather than to limit the present application. In addition, in the accompanying drawings, the similar or same structure is denoted with the same sign.

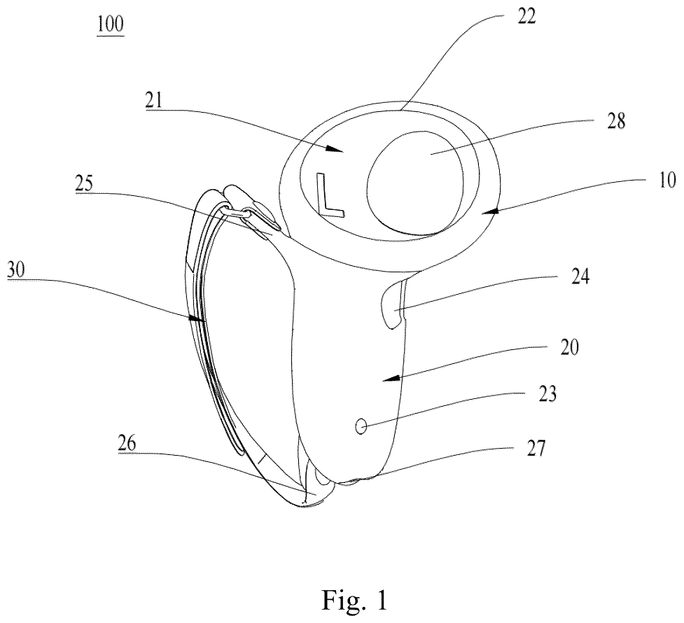

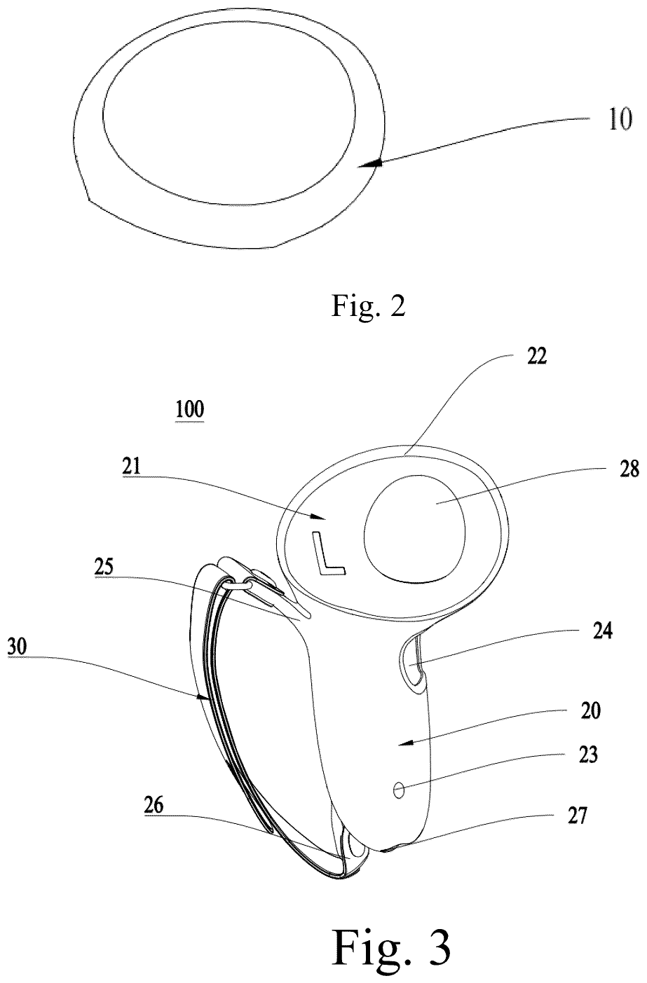

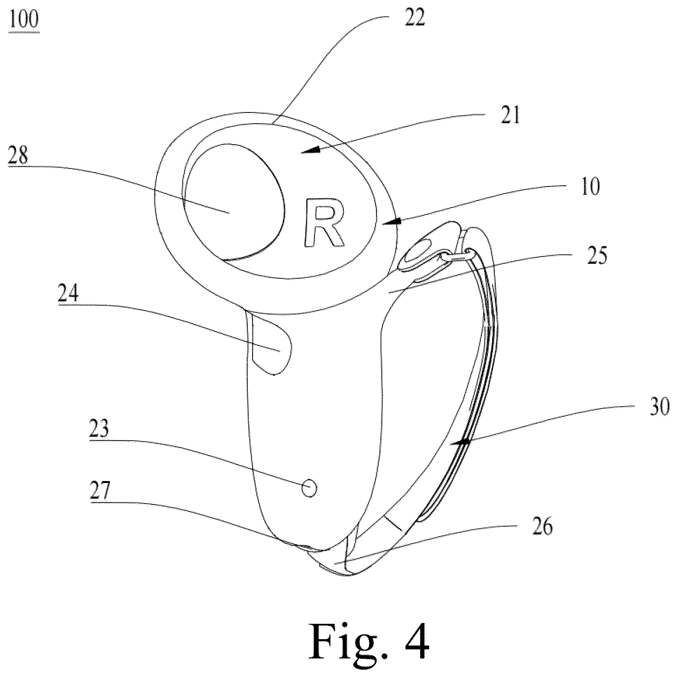

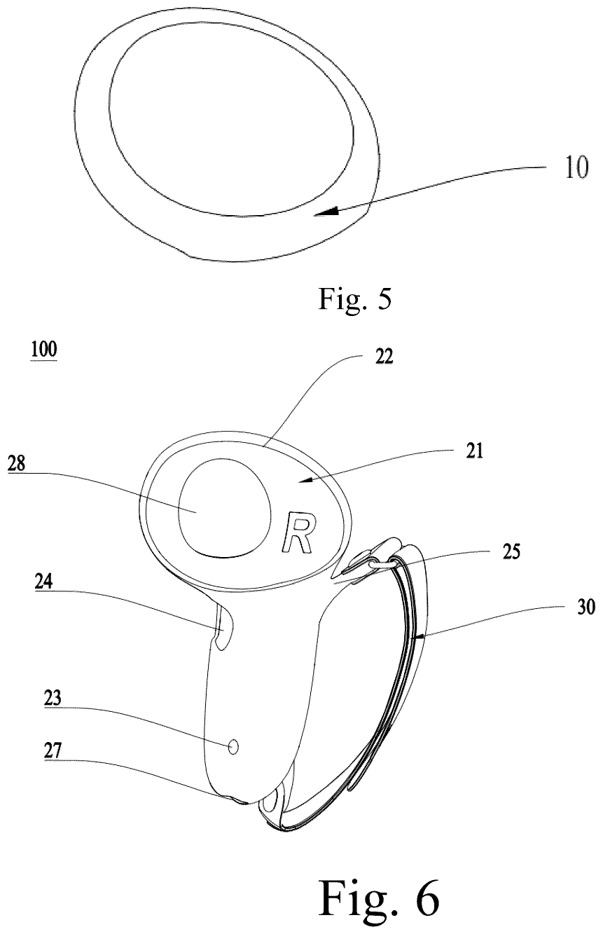

Refer to FIG. 1 to FIG. 6, FIG. 1 is an overall structural diagram of a left VR controller protective sleeve 100 provided in an embodiment of the present application; FIG. 2 is a structural diagram of a light transmitting part 10 in FIG. 1; FIG. 3 is a structural diagram of a protective sleeve main body 20 in FIG. 1; FIG. 4 is an overall structural diagram of a right VR controller protective sleeve 100 provided in an embodiment of the present application; FIG. 5 is a structural diagram of a light transmitting part 10 in FIG. 4; and FIG. 6 is a structural diagram of a protective sleeve main body 20 in FIG. 4. As shown in the figures, the VR controller protective sleeve 100 includes a light transmitting part 10 and a protective sleeve main body 20; the protective sleeve main body 20 is made of an opaque material and is provided with an accommodating cavity 21 used for accommodating at least one part of the VR controller 200; and the light transmitting part 10 is made of a light transmitting material and is disposed on a position corresponding to at least one optical signal transmission port of the VR controller 200.

Specifically, there are usually a pair of VR controllers 200 including a left VR controller and a right VR controller, and accordingly, the VR controller protective sleeve 100 includes a left VR controller protective sleeve and a right VR controller protective sleeve which are hereinafter referred to as a left protective sleeve and a right protective sleeve. Each of the left protective sleeve and the right protective sleeve includes a light transmitting part 10 and a protective sleeve main body 20. Refer to FIG. 3 and FIG. 6, the protective sleeve main body 20 is made of the opaque material and is provided with the accommodating cavity 21, the accommodating cavity 21 is provided with a first opening 22, and the light transmitting part 10 is disposed in the first opening 22. The VR controller 200 can be accommodated in the accommodating cavity 21 by the first opening 22.

The light transmitting part 10 is disposed around the first opening 22. As shown in FIG. 2 and FIG. 5, the light transmitting part 10 can be of an annular structure. Moreover, in the present embodiment, at least one part of the light transmitting part 10 extends inwards along the first opening 22 so as to fix the VR controller 200 into the accommodating cavity 21 of the protective sleeve main body 20. The light transmitting part 10 is made of a light transmitting material and can be specifically made of translucent flexible glue, and infrared signals can pass through the light transmitting part 10.

In some embodiments, such as the present embodiment, the protective sleeve main body 20 and the light transmitting part 10 are designed to be integrated, that is, they are integrated. Of course, in other embodiments, the protective sleeve main body 20 and the light transmitting part 10 are designed to be split, the protective sleeve main body 20 is made of non-transparent flexible glue, and the light transmitting part 10 is made of translucent flexible glue. As shown in FIG. 3 and FIG. 6, the light transmitting part 10 can be fixedly connected to the opening 22 of the protective sleeve main body 20 by viscose or other forms. A state of the light transmitting part 10 assembled on the protective sleeve main body 20 is shown in FIG. 1 and FIG. 4. That is, FIG. 1 and FIG. 4 show a complete product obtained after the light transmitting part 10 is assembled on the protective sleeve main body 20.

During mounting, the VR controller 200 passes through the first opening 22 and is put into the accommodating cavity 21, and at the same time, the infrared sensor of the VR controller 200 is fitted to the light transmitting part 10 and can interact with a VR device through the light transmitting part 10.

The VR controller 200 can include an induction part and a handle part. On one hand, the handle part is used for supporting the induction part, and on the other hand, the handle part is convenient for a user to hold. The induction part is provided with an operation panel and an infrared sensor and is used for achieving basic functions of the VR controller 200. When the VR controller 20 is put into the protective sleeve main body 20, the handle part is located in the accommodating cavity 21, the operation panel of the induction part is exposed outside through the first opening 22 so as to be operated by a user, and the infrared sensor of the induction part interacts with the VR device through the light transmitting part 10.

As a further embodiment, at least one second opening 23 is formed in the protective sleeve main body 20, and the second opening 23 communicates with the accommodating cavity 21.

A few of infrared sensors of parts of the VR controllers 200 can be disposed inside the handle part, and accordingly, the second opening 23 can be formed in a position, corresponding to the infrared sensor on the handle part, on the protective sleeve main body 20, which facilitates interaction between the infrared sensor disposed on the handle part and the VR device. There can be a plurality of second openings 23, positions of which correspond to a position of the infrared sensor on the handle part.

As shown in FIG. 1 and FIG. 3, the second opening 23 in the protective sleeve main body 20 of the left protective sleeve can be disposed in the right of the protective sleeve main body 20, as shown in FIG. 4 and FIG. 6, the second opening 23 of the protective sleeve main body 20 of the right protective sleeve can be disposed in the left of the protective sleeve main body 20.

As a further embodiment, a third opening 24 is formed in a part, close to the light transmitting part 10, on an inner side of the protective sleeve main body 20, and the third opening 24 communicates with the accommodating cavity 21.

In order to facilitate operating the VR device, the handle part may be provided with a control switch, the third opening 24 can be formed in a position, corresponding to the control switch, on the protective sleeve main body 20, which facilitates control performed by a user. As shown in FIG. 1 and FIG. 3, the third opening 24 in the protective sleeve main body 20 of the left protective sleeve can be formed in a position, close to the light transmitting part 10, on the right of the protective sleeve main body 20; and as shown in FIG. 4 and FIG. 6, the third opening 24 in the protective sleeve main body 20 of the right protective sleeve can be formed in a position, close to the light transmitting part 10, on the left of the protective sleeve main body 20.

As a further embodiment, the VR controller protective sleeve further includes a binding band 30 connected to an outer side of the protective sleeve main body 20.

The binding band 30 is used for fixation with a hand of a user, which can further prevent the user from throwing the VR controller 200 out.

Further, a first extension part 25 upwards extends out of a part, close to the light transmitting part 10, on the outer side of the protective sleeve main body 20, a second extension part 26 downwards extends out of the bottom of the outer side of the protective sleeve main body 20, and the first extension part 25 and the second extension part 26 are used for fixing the binding band 30.

The first extension part 25 upwards extends and forms a V shape together with the protective sleeve main body 20, the second extension part 26 downwards extends and can be parallel to the protective sleeve main body 20, one end of the binding band 30 is fixedly connected to the first extension part 25, and the other end of the binding band 30 is fixedly connected to the second extension part 26. It should be noted that a specific position of the first extension part 25 and an included angle formed by the first extension part and the protective sleeve main body 20 can be set according to an actual situation, and similarly, a specific position of the second extension part 26 and an included angle formed by the second extension part and the protective sleeve main body 20 can also be set according to an actual situation. As shown in FIG. 1 and FIG. 3, the first extension part 25 and the second extension part 26 of the protective sleeve main body 20 of the left protective sleeve can be disposed on the left of the protective sleeve main body 20; and as shown in FIG. 4 and FIG. 6, the first extension part 25 and the second extension part 26 of the protective sleeve main body 20 of the right protective sleeve can be disposed on the right of the protective sleeve main body 20.

As a further embodiment, a fourth opening 27 is further formed in the bottom of the protective sleeve main body 20, and the fourth opening 27 communicates with the accommodating cavity 21.

The fourth opening 27 is formed in the bottom of the protective sleeve main body 20, and no matter whether it is the left protective sleeve or the right protective sleeve, the fourth opening 27 is located in the bottom of the corresponding protective sleeve and is used for adapting to the handle part of the VR controller 200.

As a further embodiment, a fifth opening 28 is further formed in the protective sleeve main body 20, and the fifth opening 28 communicates with the accommodating cavity 21.

As shown in FIG. 1 and FIG. 3, the fifth opening 28 can be formed in the right of the protective sleeve main body 20 of the left protective sleeve, or as shown in FIG. 4 and FIG. 6, the fifth opening 28 can be formed in the left of the protective sleeve main body 20 of the right protective sleeve. A trigger of the VR controller 200 can be exposed on an outer side through the fifth opening 28, which facilitates control performed by a user.

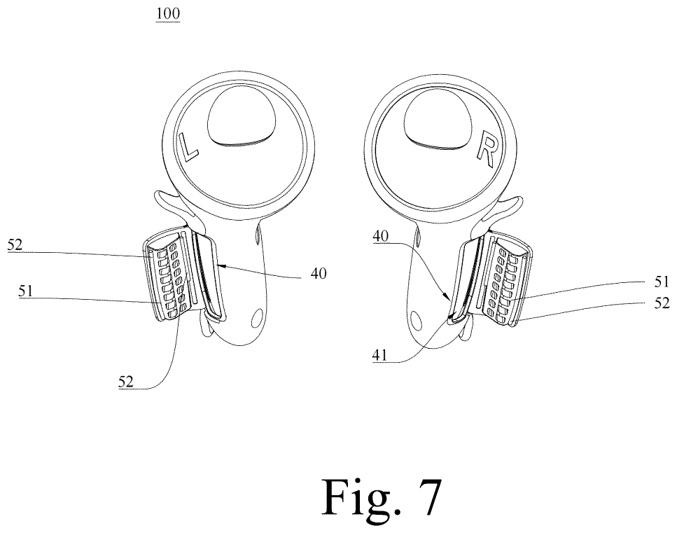

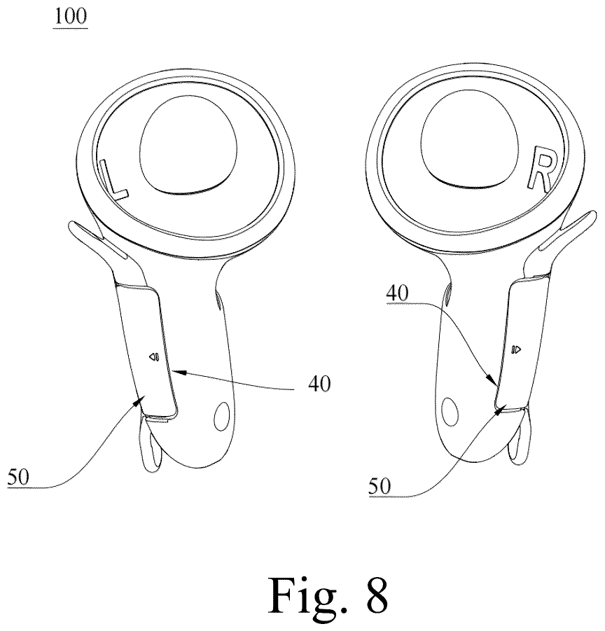

Refer to FIG. 7 and FIG. 8, as a further embodiment, the VR controller 200 is provided with a battery component, the VR controller protective sleeve 100 is provided with a battery mounting structure 40 including a mounting hole 41 and a covering member 50; the mounting hole 41 is disposed in a position, corresponding to the battery component of the VR controller 200, on the protective sleeve main body 20; and the covering member 50 is disposed in the mounting hole 41 and is connected to the protective sleeve main body 20 to cover the mounting hole 41.

The VR controller 200 can be provided with the battery component for supplying power for the VR controller 200; the battery component can be a dry battery or a rechargeable battery; if the VR controller 200 is provided with a corresponding charging circuit, the battery component can be either the charging battery or the dry battery; and if the VR controller 200 does not support charging, the battery component can be the dry battery.

The VR controller 200 is generally provided with a corresponding fixing structure for mounting the battery component, then, the mounting hole 41 is formed in a position, opposite to the battery component, on the VR controller protective sleeve 100, and the size of the mounting hole 41 is slightly greater than the size of the battery component. The shape of the mounting hole 41 can be consistent with that of the fixing structure. For example, a structure for mounting the battery component is usually a rectangular accommodating cavity, and thus, the mounting hole 41 can also be a rectangular opening.

The VR controller protective sleeve 100 can also be provided with the covering member 50 disposed in the mounting hole 41 and connected to the protective sleeve main body 20. Specifically, one side of the covering member 50 can be in flipable connection to the VR controller protective sleeve 100 to form a flip cover, and during use, the battery component can be replaced by opening the covering member 50.

As shown in FIG. 7 and FIG. 8, FIG. 7 is a structural diagram of a covering member 50 in a closed state, FIG. 8 is a structural diagram of the covering member 50 in an opened state, one side of the covering member 50 in FIG. 7 and FIG. 8 is connected to the VR controller 200, and the covering member 50 can be opened or closed by flipping.

As a further embodiment, a surface, facing the accommodating cavity 21, of the covering member 50 is provided with a convex part 51, and the convex part 51 is used for fitting to the battery component.

A surface, facing the battery component, of the convex part 51 can be an arc surface so as to facilitate directly fitting to the battery component. The covering member 50 can be provided with a first surface and a second surface, the first surface faces the battery component, the second surface faces away from the battery component, and the convex part 51 is disposed on the first surface and is set as the arc surface so as to facilitate directly fitting to the dry battery of the battery component. In addition, the thickness of the convex part 51 can be set according to a spacing between the convex part 51 and the battery component, which facilitates fitting the convex part 51 to the battery component.

As a further embodiment, two sides of the convex part 51 are provided with limiting parts 52.

When the covering member 50 is covered, the limiting parts 52 can abut against the VR controller 200 and limit a corresponding structure on the VR controller 200, thereby improving the stability of the covering member 50 during covering.

As a further embodiment, the covering member 50 can be integrated with the protective sleeve main body 20.

The covering member 50 and the protective sleeve main body 20 can be made of non-transparent flexible glue, which facilitates opening or closing the covering member 50.

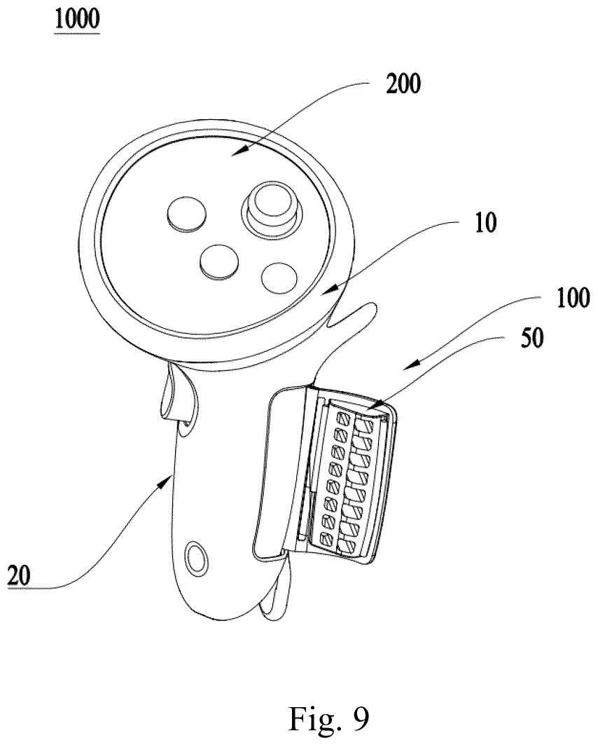

Refer to FIG. 9, the present application further provides a VR controller assembly 1000, including a VR controller 200 and the VR controller protective sleeve 100 of any one mentioned in the above-mentioned embodiments; and the VR controller protective sleeve 100 sleeves the VR controller 200.

In addition, the present application further provides a VR device including a VR host and the VR controller assembly 1000 of any one mentioned in the above-mentioned embodiments.

The VR controller protective sleeve, the VR controller assembly and the VR device which are disclosed in the present application can protect the VR controller from sliding without affecting interaction between the infrared sensor of the VR controller and the VR device, thereby improving the convenience.

Above descriptions are only specific implementations of the present application, but the protection scope of the present application is not limited thereto. All equivalent modifications or substitutions can be easily conceived by those skilled in the art within the technical scope disclosed by the present application, and these modifications or substitutions shall fall within the protection scope of the present application. Therefore, the protection scope of the present application should be subject to the protection scope defined in the claims.

1. A VR (Virtual Reality) controller protective sleeve being applied to a VR controller, and comprising:
a protective sleeve main body, the protective sleeve main body being made of an opaque material and being provided with an accommodating cavity used for accommodating at least one part of the VR controller; and
a light transmitting part, the light transmitting part being made of a light transmitting material and being disposed on a position corresponding to at least one optical signal transmission port of the VR controller.

2. The VR controller protective sleeve of claim 1, wherein the protective sleeve main body is integrated with the light transmitting part.

3. The VR controller protective sleeve of claim 1, wherein the accommodating cavity of the protective sleeve main body comprises a first opening; and
the light transmitting part is disposed in the first opening.

4. The VR controller protective sleeve of claim 3, wherein the light transmitting part is disposed around the first opening.

5. The VR controller protective sleeve of claim 3, wherein at least one part of the light transmitting part extends inwards along the first opening so as to fix the VR controller into the accommodating cavity of the protective sleeve main body.

6. The VR controller protective sleeve of claim 1, wherein the VR controller is provided with a battery component, the VR controller protective sleeve is provided with a battery mounting structure, and the battery mounting structure comprises:
a mounting hole disposed in a position, corresponding to the battery component of the VR controller, on the protective sleeve main body; and
a covering member disposed in the mounting hole and connected to the protective sleeve main body to cover the mounting hole.

7. The VR controller protective sleeve of claim 6, wherein a surface, facing the accommodating cavity, of the covering member is provided with at least one convex part, and the convex part is used for fitting to the battery component.

8. The VR controller protective sleeve of claim 7, wherein two sides of the convex part are provided with limiting parts.

9. The VR controller protective sleeve of claim 8, wherein one side of the covering member is reversibly connected to the protective sleeve main body.

10. The VR controller protective sleeve of claim 6, wherein the covering member is integrated with the protective sleeve main body.

11. A VR controller assembly, comprising:
a VR controller; and
a VR controller protective sleeve, the VR controller protective sleeve sleeving the VR controller;
wherein the VR controller protective sleeve comprises:
a protective sleeve main body, the protective sleeve main body being made of an opaque material and being provided with an accommodating cavity used for accommodating at least one part of the VR controller; and
a light transmitting part, the light transmitting part being made of a light transmitting material and being disposed on a position corresponding to at least one optical signal transmission port of the VR controller.

12. A VR device, comprising:
a VR controller;
a VR controller protective sleeve, the VR controller protective sleeve sleeving the VR controller;
and
a VR host;
wherein the VR controller protective sleeve comprises:
a protective sleeve main body, the protective sleeve main body being made of an opaque material and being provided with an accommodating cavity used for accommodating at least one part of the VR controller; and
a light transmitting part, the light transmitting part being made of a light transmitting material and being disposed on a position corresponding to at least one optical signal transmission port of the VR controller.
